(19) United States
(12) Patent Application Publication
(10) Pub. No.: US 2020/0036005 A1
(43) Pub. Date: Jan. 30, 2020

(54) POSITIVE ELECTRODE ACTIVE MATERIAL FOR NON-AQUEOUS-ELECTROLYTE SECONDARY BATTERY

(71) Applicant: PANASONIC INTELLECTUAL PROPERTY MANAGEMENT CO., LTD., Osaka-shi, Osaka (JP)

(72) Inventors: Daizo Jito, Osaka (JP); Takeshi Ogasawara, Hyogo (JP); Akihiro Kawakita, Hyogo (JP); Motoharu Saito, Hyogo (JP)

(73) Assignee: PANASONIC INTELLECTUAL PROPERTY MANAGEMENT CO., LTD., Osaka-shi, Osaka (JP)

(21) Appl. No.: 16/496,760

(22) PCT Filed: Feb. 13, 2018
(86) PCT No.: PCT/JP2018/004773

§ 371 Date: Sep. 23, 2019

(30) Foreign Application Priority Data
Mar. 30, 2017 (JP) 2017-067335

(51) Int. Cl. H01M 4/525; H01M 4/36

(52) U.S. Cl. CPC H01M 4/525; H01M 2004/028; H01M 4/362

(57) ABSTRACT

A positive electrode active material for a non-aqueous-electrolyte secondary battery contains a nickel-containing lithium transition metal oxide and is a primary particle alone of a lithium transition metal oxide that contains nickel in an amount of 80 mol % or more relative to the whole molar quantity of a metal element other than lithium or a secondary particle formed by aggregation of two to five particles. A rare earth compound and a magnesium compound adhere to the surface of the primary particle alone or the secondary particle.

### TECHNICAL FIELD

The present disclosure relates to a positive electrode active material for a non-aqueous-electrolyte secondary battery.

### BACKGROUND ART

An Ni-containing lithium transition metal oxide (such as LiNiO₂), which is one of positive electrode active materials used in lithium-ion secondary batteries, is expected to be a future positive electrode material because it has a higher electric capacity than a Co-containing lithium transition metal oxide (such as LiCoO₂) and an advantage that nickel is cheaper than cobalt and therefore stably available.

PTL 1 discloses a positive electrode active material in which a rare earth compound at least partially exists on part of matrix particles, such as LiNiO₂ particles, that can contact an electrolytic solution in order to reduce the side reaction of the electrolytic solution on the surface of the positive electrode active material and to suppress an increase in a floating current during trickle charging and storage.

PTL 2 discloses a positive electrode active material in which Mg has been incorporated into an Ni-rich positive electrode active material and which enables the crystallinity of a positive electrode to be properly reduced to enhance ion conductivity and thus improves discharge performance.

### CITATION LIST

### Patent Literature

PTL 1: International Publication No. WO 2005/008812

PTL 2: International Publication No. WO 2014/097569

### SUMMARY OF INVENTION

In matrix particles, such as LiNiO₂ particles, as a typical positive electrode active material, primary particles aggregate into secondary particles, and a rare earth compound or another material exists in the secondary particles. This technique is, however, not necessarily effective in terms of the deterioration of the secondary particles that occurs from the grain boundary; in particular, the surfaces of the secondary particles deteriorate in a high-temperature cycle, which results in a problem of a reduced electric capacity.

It is an object of the present disclosure to provide a positive electrode active material for a non-aqueous-electrolyte secondary battery, which enables an improvement of capacity retention in a high-temperature cycle.

According to an aspect of the present disclosure, there is provided a positive electrode active material for a non-aqueous-electrolyte secondary battery, the positive electrode active material containing a nickel-containing lithium transition metal oxide, wherein the nickel-containing lithium transition metal oxide is a primary particle alone of a lithium transition metal oxide that contains nickel in an amount of 80 mol % or more relative to the whole molar quantity of a metal element other than lithium or a secondary particle formed by aggregation of two to five particles, and a rare earth compound and a magnesium compound adhere to the surface of the primary particle alone or the secondary particle.

According to another aspect of the present disclosure, the lithium transition metal oxide has a circularity of 0.90 or less.

According to another aspect of the present disclosure, the amount of the adhering magnesium compound is from 0.03 to 0.5 mol % relative to the whole molar quantity of a metal element other than lithium in the nickel-containing lithium transition metal oxide.

According to another aspect of the present disclosure, the magnesium compound contains magnesium hydroxide.

According to another aspect of the present disclosure, the rare earth compound contains a hydroxide of rare earth.

According to an aspect of the present disclosure, a positive electrode active material for a non-aqueous-electrolyte secondary battery, which can improve capacity retention in a high-temperature cycle, can be provided.

### BRIEF DESCRIPTION OF DRAWINGS

FIG. 1 is a conceptual diagram illustrating the structure of a positive electrode active material according to an embodiment.

FIG. 2 is a conceptual diagram illustrating the structure of a positive electrode active material in the related art.

### DESCRIPTION OF EMBODIMENT

An Ni-containing lithium transition metal oxide as a positive electrode active material has a high electric capacity and an advantage that Ni is cheaper than Co and therefore stably available; however, the retention of electric capacity in a high-temperature cycle has been a major problem.

Typical techniques in which a rare earth compound exists on the surface of a positive electrode active material or in which Mg is incorporated have been suggested, but further improvements have been required.

The inventors have been intensively studied these techniques and focused on the particle form itself of the Ni-containing lithium transition metal oxide. In an active material in which several thousands to several tens of thousands of primary particles having an average particle size of, for example, 0.1 μm or more have aggregated into a secondary particle, a rare earth compound can reduce the deterioration of the secondary particles that occurs from the surfaces thereof but does not sufficiently reduce the deterioration that occurs from grain boundaries in the secondary particles. The inventors speculate that this phenomenon affects cycle characteristics.

Accordingly, the size of primary particles of Ni-containing lithium transition metal oxide of which the Ni content is 80 mol % or more to the whole molar quantity of a metal element other than lithium is increased to decrease the number of grain boundaries in the particles, and then a rare earth compound or another metal is made to adhere to the surface of the Ni-containing lithium transition metal oxide, thereby being able to reduce the deterioration that occurs from the particle interface.

Such an increase in the size of a primary particle is hereinafter referred to as enlargement of a primary particle in some cases. The term “enlargement of a primary particle” refers to a primary particle alone or a secondary particle in which the several number of primary particles have aggregated, and the term “the several number of primary particles” means that the number of the primary particles is approximately from two to five.

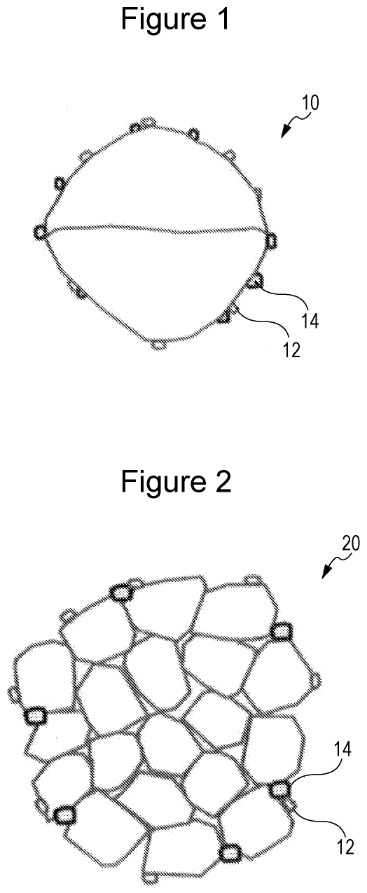

FIG. 1 is a conceptual diagram illustrating the structure of an Ni-containing lithium transition metal oxide 10 according to an embodiment. The state in which two primary particles have aggregated into a secondary particle is schematically illustrated. Since merely the several number of primary particles aggregate, the number of grain boundaries is obviously relatively small.

FIG. 1 further schematically illustrates the state in which a rare earth compound 12 and a magnesium compound 14 are adhering to the surface of the Ni-containing lithium transition metal oxide 10 of which the primary particles have been enlarged. The rare earth compound 12 can suppress the side reaction of an electrolytic solution on the surface of the Ni-containing lithium transition metal oxide 10 and can reduce the deterioration of the surface in a high-temperature cycle. The magnesium compound 14 affects the rare earth compound 12 to reduce the deterioration of the rare earth compound 12, so that an effect that the rare earth compound 12 suppresses the deterioration of the surface of the Ni-containing lithium transition metal oxide 10 can be continuously maintained.

FIG. 2 is a conceptual diagram illustrating the structure of an Ni-containing lithium transition metal oxide 20 of the related art. Unlike to FIG. 1, a number of small primary particles aggregate (although the illustration in the drawing is schematic, several thousands and several tens of thousands of particles aggregate in fact).

Accordingly, the number of grain boundaries between the primary particles is relatively large.

As in FIG. 1, FIG. 2 further schematically illustrates the state in which the rare earth compound 12 and the magnesium compound 14 are adhering to the surface of the Ni-containing lithium transition metal oxide 20. As in the case of FIG. 1, the rare earth compound 12 can suppress the side reaction of an electrolytic solution on the surface of the Ni-containing lithium transition metal oxide 10, and the magnesium compound 14 can affect the rare earth compound 12 to reduce the deterioration of the rare earth compound 12; however, it is hard to suppress the deterioration that occurs from many grain boundaries, and thus the effect that the rare earth compound 12 and the magnesium compound 14 suppress the deterioration is obviously limited.

In view of such a mechanism, the primary particle of the Ni-containing lithium transition metal oxide is enlarged in the embodiment, and also the rare earth compound and the magnesium compound adhere to the surface thereof, so that the deterioration of the Ni-containing lithium transition metal oxide is suppressed to maintain electric capacity in a high-temperature cycle.

The structure of a positive electrode active material for a non-aqueous-electrolyte secondary battery according to an embodiment of the present disclosure will now be described in detail.

The Ni-containing lithium transition metal oxide, for example, has a layered structure, and examples thereof include a layered structure belonging to a space group R-3m and a layered structure belonging to a space group C2/m. Among them, a layered structure belonging to a space group R-3m is preferred in terms of, for instance, an increase in electric capacity and the stability of a crystal structure.

The amount of the Ni-containing lithium transition metal oxide is, for instance, preferably 90 mass % or more, and preferably 99 mass % or more relative to the total mass of the positive electrode active material for a non-aqueous-electrolyte secondary battery because such an amount enables an enhancement in the charge-discharge capacity of a non-aqueous-electrolyte secondary battery.

The positive electrode active material for a non-aqueous-electrolyte secondary battery according to the embodiment may further contain another lithium transition metal oxide in addition to the Ni-containing lithium transition metal oxide. Examples of such another lithium transition metal oxide include lithium transition metal oxides of which the Ni content is 0 mol % or more but less than 80 mol % and traditional Ni-containing lithium transition metal oxides of which the Ni content is 80 mol % or more and of which the primary particle is not enlarged.

The Ni-containing lithium transition metal oxide is not particularly limited; for example, it preferably contains at least one of nickel (Ni), cobalt (Co), manganese (Mn), and aluminum (Al); and more preferably nickel (Ni), cobalt (Co), or aluminum (Al). In particular, it is preferably a lithium-containing nickel-manganese composite oxide, a lithium-containing nickel-cobalt-manganese composite oxide, or a lithium-containing nickel-cobalt composite oxide; and more preferably a lithium-containing nickel-cobalt-aluminum composite oxide. The Ni content in the lithium-containing nickel-cobalt-aluminum composite oxide is preferably 80 mol % or more relative to the whole molar quantity of metal elements but lithium (Li). Such an oxide enables the positive electrode to have a high electric capacity.

The Ni-containing lithium transition metal oxide may further contain another additional element. Examples of the additional element include boron (B), magnesium (Mg), titanium (Ti) chromium (Cr), iron (Fe), copper (Cu), zinc (Zn), niobium (Nb), molybdenum (Mo), tantalum (Ta), zirconium (Zr), tin (Sn), tungsten (W), sodium (Na), potassium (K), barium (Ba), strontium (Sr), calcium (Ca), and bismuth (Bi).

The Ni-containing lithium transition metal oxide is, for example, preferably an Ni-containing lithium transition metal oxide represented by Compositional Formula (1).

LiₓNi_{α}CoₚM_{q}O₂ (1)

In the formula, x, α, p, and q preferably satisfy 0.95<x<1.05, 0.80≤α<1, 0<p<0.15, and 0<q<0.15, respectively. In the formula, M represents a metal element other than Ni and Co and, for example, includes one or more metal elements selected from Al, B, Mg, Ti, Cr, Fe, Cu, Zn, Nb, Mo, Ta, Zr, Sn, W, Na, K, Ba, Sr, Ca, and Bi.

In Compositional Formula (1), x is, for example, preferably in the range of 0.95<x<1.05, and more preferably 0.98<x≤1 because it enables an enhancement in the charge-discharge capacity of the non-aqueous-electrolyte secondary battery.

In Compositional Formula (1), α is, for instance, preferably in the range of 0.80≤α<1, and more preferably 0.85<α<1 because it enables an enhancement in the charge-discharge capacity of the non-aqueous-electrolyte secondary battery.

In Compositional Formula (1), p is, for example, preferably in the range of 0<p<0.15, and more preferably 0.03<α<0.12 because it enables enhancements in the charge-discharge cycle characteristics and charge-discharge capacity of the non-aqueous-electrolyte secondary battery.

In Compositional Formula (1), q is, for instance, preferably in the range of 0<q<0.15, and more preferably 0.005<q<0.1 because it enables enhancements in the charge-discharge cycle characteristics and charge-discharge capacity of the non-aqueous-electrolyte secondary battery.

The Ni-containing lithium transition metal oxide according to the embodiment can be, for example, synthesized by the following method. A lithium-containing compound, such as lithium hydroxide, and an oxide containing nickel and the metal element exemplified above are mixed with each other at a mixing ratio based on the intended Ni-containing lithium transition metal oxide. A potassium compound is further added to this mixture. The mixture that contains the lithium-containing compound, the oxide containing nickel and a metal element, and the potassium compound is burned in the atmosphere or in an oxygen flow. The burned product is washed with water to remove the potassium compound adhering to the surface of the burned product.

The Ni-containing lithium transition metal oxide synthesized by the above-mentioned method has a specific X-ray diffraction pattern described above, an increased single-crystal particle size, and a specific particle size distribution that will be described later. Although the detail of its mechanism has been still studied, it is believed that the addition of a potassium compound to the mixture enables the uniform growth of single crystal particles throughout the mixture phase in the burning procedure.

Examples of the potassium compound used in the above-mentioned synthesis include potassium hydroxide (KOH), salts thereof, and potassium acetate. The amount of the potassium compound is, for example, from 0.1 mass % to 100 mass % relative to the Ni-containing lithium transition metal oxide that is to be synthesized. The burning temperature in the above-mentioned synthesis is, for instance, approximately from 600 to 1100° C., and the burning time is approximately from 1 to 50 hours in the case where the burning temperature is from 600 to 1100° C.

The Ni-containing lithium transition metal oxide is a primary particle alone or a secondary particle formed by aggregation of several (two to five) primary particles. The number of the primary particles can be, for example, measured with a scanning electron microscope (SEM). The circularity of the Ni-containing lithium transition metal oxide is not particularly limited but preferably 0.9 or less. The circularity is the index of the spherical shape of the Ni-containing lithium transition metal oxide particles projected to a two-dimensional plane. The circularity of 0.9 or less is believed to make the rare earth compound and magnesium compound easily adhere to the surfaces of the Ni-containing lithium transition metal oxide particles. The circularity can be determined as follows: particles as a sample are put into a measuring system, stroboscopic light is radiated to a sample fluid to take the picture of the particles, and the circularity is determined on the basis of this picture. The circularity is calculated from the following formula.

(Circularity)=(Circumferential length of a circle having the same area as the particle in the picture)/(Circumferential length of the particle in the picture)

The circumferential length of a circle having the same area as the particle in the picture and the circumferential length of the particle in the picture are determined by the image processing of the particle in the picture. In the case where the particle in the picture is a perfect circle, circularity is one.

The amount of the adhering rare earth compound is preferably from 0.005 to 0.1 mol %, and more preferably from 0.005 to 0.05 mol % relative to the whole molar quantity of a metal element other than lithium in the Ni-containing lithium transition metal oxide.

The amount of the adhering magnesium compound is preferably from 0.03 to 0.5 mol %, and more preferably from 0.03 to 0.1% relative to the whole molar quantity of a metal element other than lithium in the Ni-containing lithium transition metal oxide.

In the case where the amounts of the adhering rare earth compound and magnesium compound are too small, the effect of suppressing deterioration becomes insufficient; in the case where the amounts of the adhering rare earth compound and magnesium compound are in excess, the electric capacity decreases. From such points of view, the amounts of the adhering compounds may be optimally determined. Specifically, in the case where the amount of the rare earth compound is in excess, the surface of the lithium transition metal oxide is unnecessarily covered, which results in a reduction in the cycle characteristics in large current discharge in some cases. The inventors have found that the effect of retaining the electric capacity is particularly large when the amounts of the adhering rare earth compound and magnesium compound are 0.05% and 0.1 mol % relative to the transition metal as in Examples described later, respectively; however, the amounts of the adhering compounds are not limited thereto.

The particles of the rare earth compound are made to adhere to the surface of the Ni-containing lithium transition metal oxide, and the term “adhere” refers to that the particles of the rare earth compound are in the state in which they are strongly bonded to the surface of the Ni-containing lithium transition metal oxide and not easily separated therefrom; for example, even when the positive electrode active material is subjected to ultrasonic dispersion, the particles of the rare earth compound are not removed from the surface. The rare earth compound adhering to the surface can suppress reductions in the discharge voltage and discharge capacity after a charge-discharge cycle. Although the mechanism thereof has been still studied, such an effect is believed to be produced owing to an enhancement in the stability of the crystal structure of the composite oxide. An enhancement in the stability of the crystal structure of the composite oxide reduces a change in the crystal structure in a charge-discharge cycle, so that an increase in interface reaction resistance can be suppressed in Li ion insertion and desorption.

A rare earth element contained in the rare earth compound is at least one element selected from scandium, yttrium, lanthanum, cerium, praseodymium, neodymium, samarium, europium, gadolinium, terbium, dysprosium, holmium, erbium, thulium, ytterbium, and lutetium. Among these elements, neodymium, samarium, and erbium are particularly preferable. Compounds of neodymium, samarium, or erbium are especially excellent in, for example, an effect of reducing the surface deterioration that may occur at the surfaces of the Ni-containing lithium transition metal oxide particles as compared with other rare earth compounds.

Specific examples of the rare earth compound include hydroxides such as neodymium hydroxide, samarium hydroxide, and erbium hydroxide; oxyhydroxides such as neodymium oxyhydroxide, samarium oxyhydroxide, and erbium oxyhydroxide; phosphate compounds such as neodymium phosphate, samarium phosphate, and erbium phosphate; carbonate compounds such as neodymium carbonate, samarium carbonate, and erbium carbonate; oxides such as neodymium oxide, samarium oxide, and erbium oxide; and fluorine compounds such as neodymium fluoride, samarium fluoride, and erbium fluoride. Among these rare earth compounds, erbium hydroxide is preferred in terms of adhesion to the Ni-containing lithium transition metal oxide.

Examples of the magnesium compound include magnesium hydroxide, magnesium sulfate, magnesium nitrate, magnesium oxide, magnesium carbonate, magnesium halide, dialkoxy magnesium, and dialkyl magnesium. Among these magnesium compounds, magnesium hydroxide is preferred in terms of adhesion to the Ni-containing lithium transition metal oxide.

A process for making the rare earth compound and the magnesium compound adhere to the surface of the Ni-containing lithium transition metal oxide, for example, includes a first step for attaching the rare earth compound and the magnesium compound to the Ni-containing lithium transition metal oxide and a second step for heating the resulting product at a heat treatment temperature of 300° C. or lower.

Examples of the first step includes mixing a suspension liquid in which the Ni-containing lithium transition metal oxide particles have been dispersed with a solution of the rare earth compound and magnesium compound in water or another material and spraying a solution of the rare earth compound and magnesium compound to the Ni-containing lithium transition metal oxide particles. In the above-mentioned washing with water for removing the potassium compound, a solution of the rare earth compound and magnesium compound in water or another material may be used in combination. When an aqueous solution in which rare earth elements and the magnesium compound have been dissolved is added to a suspension liquid in which the Ni-containing lithium transition metal oxide has been dispersed, merely using an aqueous solution causes the deposition of hydroxides of the individual compounds.

In the second step of heating, the heat treatment temperature is desirably 300° C. or less. This is because a temperature of greater than 300° C. may cause a change in the phase of the Ni-containing lithium transition metal oxide. The lower limit of the temperature is desirably 80° C. or more. This is because a temperature of less than 80° C. may result in, for instance, the occurrence of a decomposition reaction of the electrolyte due to adsorbed moisture. For the same reason, the heating is preferably carried out under vacuum.

An example of a non-aqueous-electrolyte secondary battery in which the positive electrode active material for a non-aqueous-electrolyte secondary battery that contains the Ni-containing lithium transition metal oxide is used will now be described.

The non-aqueous-electrolyte secondary battery, for example, includes an electrode body in which a positive electrode and a negative electrode have been wound or stacked with a separator interposed therebetween, a non-aqueous electrolyte, and an exterior casing that accommodates the electrode body and the non-aqueous electrolyte. The non-aqueous-electrolyte secondary battery may be in any shape; for instance, it may be in the form of a cylinder, square, coin, button, or laminate.

[Positive Electrode]

The positive electrode, for example, includes a positive electrode current collector, such as metal foil, and a positive electrode active material layer formed on the positive electrode current collector. A usable positive electrode current collector is the foil of metal that is stable within the potential of the positive electrode, such as aluminum, or a film having a surface layer of such metal.

The positive electrode active material layer, for example, contains the positive electrode active material for a non-aqueous-electrolyte secondary battery that contains the Ni-containing lithium transition metal oxide, a conductive material, and a binder.

Examples of the conductive material include carbon materials such as carbon black, acetylene black, KETJENBLACK, and graphite. The conductive material content is, for instance, preferably from 0.1 to 30 mass %, more preferably from 0.1 to 20 mass %, and especially preferably from 0.1 to 10 mass % relative to the total mass of the positive electrode active material layer, for instance, in order to enhance the conductivity of the positive electrode active material layer.

Examples of the binder include polytetrafluoroethylene (PTFE), polyvinylidene fluoride, polyvinyl acetate, polymethacrylate, polyacrylate, polyacrylonitrile, and polyvinyl alcohol. The binder may be used in combination with a thickener such as carboxymethyl cellulose (CMC) or polyethylene oxide (PEO). The binder content may be, for example, preferably from 0.1 to 30 mass %, more preferably from 0.1 to 20 mass %, and especially preferably from 0.1 to 10 mass % relative to the total mass of the positive electrode active material layer, for example, in order to enhance the adhesion of the positive electrode active material layer to the positive electrode current collector.

[Negative Electrode]

The negative electrode, for example, includes a negative electrode current collector, such as metal foil, and a negative electrode active material layer formed on the surface of the negative electrode current collector. A usable negative electrode current collector is the foil of metal that is stable within the potential of the negative electrode, such as aluminum or copper, or a film having a surface layer of such metal. The negative electrode active material layer suitably contains a binder in addition to the negative electrode active material that can store and release lithium ions. The negative electrode active material layer may optionally contain a conductive material.

Examples of a usable negative electrode active material include natural graphite, artificial graphite, lithium, silicon, carbon, tin, germanium, aluminum, lead, indium, gallium, lithium alloys, lithium-storing carbon and silicon, and alloys of these substances. The binder may be the same material as in the positive electrode; however, it is preferably a styrene-butadiene copolymer (SBR) or a modified product thereof. The binder may be used in combination with a thickener such as CMC.

[Non-Aqueous Electrolyte]

The non-aqueous electrolyte contains a non-aqueous solvent and an electrolyte salt dissolved in the non-aqueous solvent. The non-aqueous electrolyte is not limited to a liquid electrolyte (non-aqueous electrolytic solution) and may be a solid electrolyte such as a gel polymer electrolyte. Examples of a usable non-aqueous solvent include esters, ethers, nitriles such as acetonitrile, amides such as dimethylformamide, and mixed solvents of two or more of these solvents.

Examples of the esters include cyclic carbonates such as ethylene carbonate, propylene carbonate, and butylene carbonate; chain carbonates such as dimethyl carbonate, methylethyl carbonate, diethyl carbonate, methylpropyl carbonate, ethylpropyl carbonate, and methylisopropyl carbonate; and carboxylate such as methyl acetate, ethyl acetate, propyl acetate, methyl propionate, ethyl propionate, and γ-butyrolactone.

Examples of the ethers include cyclic ethers, such as 1,3-dioxolane, 4-methyl-1,3-dioxolane, tetrahydrofuran, 2-methyltetrahydrofuran, propylene oxide, 1,2-butylene oxide, 1,3-dioxane, 1,4-dioxane, 1,3,5-trioxane, furan, 2-methylfuran, 1,8-cineole, and crown ethers, and chain ethers such as 1,2-dimethoxyethane, diethyl ether, dipropyl ether, diisopropyl ether, dibutyl ether, dihexyl ether, ethyl vinyl ether, butyl vinyl ether, methyl phenyl ether, ethyl phenyl ether, butyl phenyl ether, pentyl phenyl ether, methoxytoluene, benzyl ethyl ether, diphenyl ether, dibenzyl ether, o-dimethoxybenzene, 1,2-diethoxyethane, 1,2-dibutoxyethane, diethylene glycol dimethyl ether, diethylene glycol diethyl ether, diethylene glycol dibutyl ether, 1,1-dimethoxymethane, 1,1-diethoxyethane, triethylene glycol dimethyl ether, and tetraethylene glycol dimethyl ether.

The non-aqueous solvent suitably contains a halogen-substituted compound resulting from the substitution of the hydrogen atoms of any of the above-mentioned solvents with halogen atoms such as fluorine atoms. In particular, the non-aqueous solvent preferably contains a fluorinated cyclic carbonate or a fluorinated chain carbonate, and more preferably a mixture of these two carbonates. This enables formation of good protective films on the negative electrode and also on the positive electrode, which leads to an enhancement in cycle characteristics. Suitable examples of the fluorinated cyclic carbonate include 4-fluoroethylene carbonate, 4,5-difluoroethylene carbonate, 4,4-difluoroethylene carbonate, 4,4,5-trifluoroethylene carbonate, and 4,4,5,5-tetrafluoroethylene carbonate. Suitable examples of the fluorinated chain carbonate include ethyl 2,2,2-trifluoroacetate, methyl 3,3,3-trifluoropropionate, and methyl pentafluoropropionate.

The electrolyte salt is preferably a lithium salt. Examples of the lithium salt include LiPF₆, LiBF₄, LiAsF₆, LiClO₄, LiCF₃SO₃, LiN(FSO₂)₂, LiN(C₁F₂₁₊₁SO₂) (CₘF₂ₘ₊₁SO₂) (l and m are each an integer of 1 or more), LiC(CₚF2ₚ₊₁SO₂) (C_{q}F_{2q+1}SO₂) (CᵣF₂ᵣ₊₁SO₂) (p, q, and r are each an integer of 1 or more), Li[B(C₂O₄)₂] (lithium bis(oxalato)borate (LiBOB)), Li[B(C₂O₄)F₂], Li[P(C₂O₄)F₄],

Li[P (C₂O₄)₂F₂], and LiPO₂F₂.

[Separator]

The separator may be, for example, a porous sheet having ion permeability and insulating properties. Specific examples of the porous sheet include microporous thin films, woven fabrics, and non-woven fabrics. Suitable examples of the material of the separator include olefin resins, such as polyethylene and polypropylene, and celluloses. The separator may be a laminate having a cellulose fiber layer and a thermoplastic resin fiber layer such as an olefin resin layer.

### EXAMPLE 1

The present disclosure will now be further described with reference to EXAMPLES but is not limited thereto.

### First Experimental Example

### Example 1

[Preparation of Positive Electrode Active Material (Layered Oxide)]

A nickel-cobalt-aluminum composite hydroxide represented by a compositional formula Ni_{0.88}Co_{0.09}Al_{0.03}(OH)₂ was prepared by coprecipitation and then heated at 500° C. to yield a NiCoAl composite oxide. LiOH and the NiCoAl composite oxide were mixed with each other in such amounts that the total of Li and metals other than Li (Ni, Co, and Al) had a molar ratio of 1.03:1. Furthermore, KOH was added to this mixture in an amount of 10 mass % relative to the estimated composition of an Ni-containing lithium transition metal oxide (Li_{1.03}Ni_{0.88}Co_{0.09}Al_{0.03}O₂). Then, the resulting mixture was burned in an oxygen flow at 750° C. for 40 hours, and the burned product was washed with water to remove KOH adhering to the surface thereof, thereby yielding an Ni-containing lithium transition metal oxide.

The composition of the Ni-containing lithium transition metal oxide was measured with an ICP emission spectrophotometer (manufactured by Thermo Fisher Scientific, trade name “iCAP6300”), and the Ni-containing lithium transition metal oxide was identified as a composite oxide represented by a compositional formula Li_{1.03}Ni_{0.88}Co_{0.09}Al_{0.03}O₂.

Particles of the Ni-containing lithium transition metal oxide before the washing with water were prepared in an amount of 1000 g and added to 1.5 L of pure water, and this solution was stirred to prepare a suspension liquid in which the lithium transition metal oxide had been dispersed in the pure water. Then, 0.1 mol/L of an aqueous solution of erbium sulfate prepared by dissolving erbium oxide in sulfuric acid and 1.0 mol/L of an aqueous solution of magnesium sulfate were added stepwise to the suspension liquid. The pH of the suspension liquid was from 11.5 to 12.0 during the addition of the aqueous solutions thereto. The suspension liquid was subsequently filtrated, and obtained powder was washed with pure water and then dried at 200° C. under vacuum. The amounts of adhering erbium compound and magnesium compound in the obtained positive electrode active material were measured by an ICP emission spectrochemical analysis, and the amounts of the adhering erbium and magnesium were 0.09 mass % and 0.03 mass % relative to the Ni-containing lithium transition metal oxide on an element basis (0.05 mol % and 0.10 mol % relative to the whole molar quantity of the metal elements other than lithium elements in the nickel-containing lithium transition metal oxide), respectively.

[Formation of Positive Electrode]

The positive electrode active material, carbon black, and a N-methyl-2-pyrrolidone solution in which polyvinylidene fluoride had been dissolved were weighed so that the positive electrode active material, the conductive material, and the binder had a mass ratio of 100:1:1. These materials were kneaded with T.K. HIVIS MIX (manufactured by PRIMIX Corporation) to prepare a positive electrode mixture slurry.

Then, the positive electrode mixture slurry was applied to the both sides of the positive electrode current collector formed of aluminum foil. The coating films were dried and then rolled with a mill roll, and an aluminum current collecting tab was attached to the current collector, thereby producing a positive electrode plate in which each side of the positive electrode current collector had a positive electrode mixture layer. The positive electrode active material of the positive electrode had a packing density of 3.60 g/cm³.

[Preparation of Non-Aqueous Electrolyte]

Ethylene carbonate (EC), methylethyl carbonate (MEC), and dimethyl carbonate (DMC) were mixed with each other at a volume ratio of 2:2:6. Lithium hexafluorophosphate (LiPF₆) was dissolved in this mixed solvent at a concentration of 1.3 mol/L, and vinylene carbonate (VC) was dissolved in this mixed solvent at a concentration of 2.0 mass %.

[Formation of Negative Electrode]

Artificial graphite as a negative electrode active material, CMC (sodium carboxymethylcellulose), and SBR (styrene-butadiene rubber) were mixed with each other in an aqueous solution at a mass ratio of 100:1:1 to prepare a negative electrode mixture slurry. The negative electrode mixture slurry was uniformly applied to the both sides of a negative electrode current collector formed of copper foil. Then, the coating films were dried and rolled with a mill roll, and a nickel current collecting tab was attached to the current collector. In this manner, a negative electrode plate in which each side of the negative electrode current collector had a negative electrode mixture layer was produced. The negative electrode active material of the negative electrode had a packing density of 1.75 g/cm³.

[Production of Test Cell]

The positive electrode and negative electrode produced in the above-mentioned manners were wound in spirals with a separator interposed between the electrodes, and then the winding core was pulled out to produce a spiral electrode body. Then, this spiral electrode body was compressed to produce a flat electrode body. This flat electrode body and the non-aqueous electrolytic solution were put into an exterior casing formed of an aluminum laminate to produce a test cell. The size of this cell was thickness of 3.6 mm×width of 35 mm×length of 62 mm. The non-aqueous-electrolyte secondary battery was charged to 4.20 V and then discharged to 3.0 V: in this case, the discharge capacity was 950 mAh.

### Comparative Example 1

An Ni-containing lithium transition metal oxide was produced as in Example 1 except that the rare earth compound did not adhere in the preparation of the positive electrode active material. This Ni-containing lithium transition metal oxide was used as a positive electrode active material of Comparative Example 1, and a test cell was produced as in Example 1.

### Comparative Example 2

An Ni-containing lithium transition metal oxide was produced as in Example 1 except that the magnesium compound did not adhere in the preparation of the positive electrode active material. This Ni-containing lithium transition metal oxide was used as a positive electrode active material of Comparative Example 2, and a test cell was produced as in Example 1.

### Comparative Example 3

An Ni-containing lithium transition metal oxide was produced as in Example 1 except that the rare earth compound and the magnesium compound did not adhere in the preparation of the positive electrode active material. This Ni-containing lithium transition metal oxide was used as a positive electrode active material of Comparative Example 3, and a test cell was produced as in Example 1.

### Comparative Example 4

In the preparation of the positive electrode active material, KOH was not used, and the burning was carried out at 760° C. for 20 hours. Except for these changes, an Ni-containing lithium transition metal oxide formed by aggregation of a number of small primary particles was produced as in Example 1. This Ni-containing lithium transition metal oxide was used as a positive electrode active material of Comparative Example 4, and a test cell was produced as in Example 1.

### Comparative Example 5

An Ni-containing lithium transition metal oxide was produced as in Comparative Example 4 except that the rare earth compound and the magnesium compound did not adhere in the preparation of the positive electrode active material. This Ni-containing lithium transition metal oxide was used as a positive electrode active material of Comparative Example 5, and a test cell was produced as in Example 1.

[Charge-Discharge Cycle Test]

At a temperature condition of 45° C., the test cells of Example 1 and Comparative Examples 1 to 5 were charged at a constant current of 475 mA to a voltage of 4.2 V and then at a constant voltage of 4.2 V to a current of 30 mA. The test cells subsequently discharged electricity at a constant current of 475 mA to a voltage of 3.0 V. This cycle of charge and discharge was repeated 100 times. The intervals between the charge and the discharge and between the discharge and another charge was 10 minutes. The percentage of the discharge capacity at the 100th cycle to the initial discharge capacity was defined as capacity retention. The more the value of the capacity retention is, the more a reduction in high-temperature cycle characteristics is suppressed.

Table 1 shows results in Example 1 and Comparative Examples 1 to 5. Table 1 shows relative values based on the assumption that the capacity retention in Comparative Examples 3 and 5 are defined as a standard value of 100%.

TABLE 1

| | | Amount of | Amount of | Retention |
|---|---|---|---|---|
| | | adhering Mg | adhering rare | after 100 |
| | Particle | compound | earth compound | cycles |
| | type | (mol %) | (mol %) | (%) |
| Example 1 | Large | 0.1 | 0.05 | 114 |
| | primary | | | |
| | particles | | | |
| Comparative | Large | 0.1 | 0 | 101 |
| Example 1 | primary | | | |
| | particles | | | |
| Comparative | Large | 0 | 0.05 | 103 |
| Example 2 | primary | | | |
| | particles | | | |
| Comparative | Large | 0 | 0 | 100 |
| Example 3 | primary | | | |
| | particles | | | |
| Comparative | Small | 0.1 | 0.05 | 102 |
| Example 4 | primary | | | |
| | particles | | | |
| Comparative | Small | 0 | 0 | 100 |
| Example 5 | primary | | | |
| | particles | | | |

Example 1 had a greatly larger capacity retention than Comparative Examples 1 to 5. This result shows that the enlargement of the primary particle of the Ni-containing lithium transition metal oxide and adhesion of the rare earth compound and magnesium compound to the surface thereof enables an improvement in high-temperature cycle characteristics.

### Second Experimental Example

### Example 2

An Ni-containing lithium transition metal oxide was produced as in Example 1 except that the aqueous solution of erbium sulfate was replaced with a samarium sulfate solution in the production of the positive electrode active material. This Ni-containing lithium transition metal oxide was used as a positive electrode active material of Example 2 to produce a test cell and perform the cycle test as in Example 1. The amount of the adhering samarium compound was measured by an ICP emission spectrochemical analysis and found to be 0.08 mass % relative to the Ni-containing lithium transition metal oxide on a samarium element basis.

### Example 3

An Ni-containing lithium transition metal oxide was produced as in Example 1 except that the aqueous solution of erbium sulfate was replaced with a neodymium sulfate solution in the production of the positive electrode active material. This Ni-containing lithium transition metal oxide was used as a positive electrode active material of Example 3 to produce a test cell and perform the cycle test as in Example 1. The amount of the adhering neodymium compound was measured by an ICP emission spectrochemical analysis and found to be 0.08 mass % relative to the Ni-containing lithium transition metal oxide on a neodymium element basis.

Table 2 shows results in Examples 1 to 3. Table 2 shows relative values based on the assumption that the capacity retention in Comparative Example 3 is defined as a standard value of 100%.

TABLE 2

| | | | | Amount of | |
|---|---|---|---|---|---|
| | | | Amount of | adhering | Retention |
| | | Rare | adhering Mg | rare earth | after 100 |
| | Particle | earth | compound | compound | cycles |
| | type | element | (mol %) | (mol %) | (%) |
| Example 1 | Large | Er | 0.1 | 0.05 | 114 |
| | primary | | | | |
| | particles | | | | |
| Example 2 | Large | Sm | 0.1 | 0.05 | 113 |
| | primary | | | | |
| | particles | | | | |
| Example 3 | Large | Nd | 0.1 | 0.05 | 112 |
| | primary | | | | |
| | particles | | | | |
| Comparative | Large | None | 0 | 0 | 100 |
| Example 3 | primary | | | | |
| | particles | | | | |

Examples 2 and 3 had a greatly large capacity retention as in Examples in which samarium and neodymium, which are rare earth elements like erbium, adhere. From this result, it is concluded that also using rare earth elements other than erbium, samarium, and neodymium gives greatly large capacity retention.

### REFERENCE SIGNS LIST

10 Ni-containing lithium transition metal oxide

12 Rare earth compound

14 Magnesium compound

20 Traditional Ni-containing lithium transition metal oxide

1. A positive electrode active material for a non-aqueous-electrolyte secondary battery, the positive electrode active material comprising a nickel-containing lithium transition metal oxide, wherein
the nickel-containing lithium transition metal oxide is a primary particle alone of a lithium transition metal oxide that contains nickel in an amount of 80 mol % or more relative to the whole molar quantity of a metal element other than lithium or a secondary particle formed by aggregation of two to five particles, and a rare earth compound and a magnesium compound adhere to the surface of the primary particle alone or the secondary particle.

2. The positive electrode active material for a non-aqueous-electrolyte secondary battery according to claim 1, wherein the lithium transition metal oxide has a circularity of 0.90 or less.

3. The positive electrode active material for a non-aqueous-electrolyte secondary battery according to claim 1, wherein the amount of the adhering magnesium compound is from 0.03 to 0.5 mol % relative to the whole molar quantity of a metal element other than lithium in the nickel-containing lithium transition metal oxide.

4. The positive electrode active material for a non-aqueous-electrolyte secondary battery according to claim 1, wherein the magnesium compound contains magnesium hydroxide.

5. The positive electrode active material for a non-aqueous-electrolyte secondary battery according to claim 1, wherein the rare earth compound contains a hydroxide of rare earth.
